(19) United States
(12) Patent Application Publication
(10) Pub. No.: US 2016/0076727 A1
(43) Pub. Date: Mar. 17, 2016

(54) LIGHT EMITTING DIODE LIGHTING DEVICE AND HOUSING

(71) Applicant: E I DU PONT DE NEMOURS AND COMPANY, Wilmington, DE (US)

(72) Inventors: STEVEN C. PESEK, Orange, TX (US); Shannon D. Meerscheidt, Bridge City, TX (US); W. Alexander Shaffer, Orange, TX (US); David M. Dean, West Chester, PA (US); Sebastien Tindilliere, Geneva (CH); George Wyatt Prejean, Orange, TX (US); William J. Glick, Wilmington, DE (US); Charles Anthony Smith, Vienna, WV (US); Karlheinz Hausmann, Auvernier (CH); Loic Pierre Rolland, Divonne Les Bains (FR)

(21) Appl. No.: 14/856,868

(22) Filed: Sep. 17, 2015

Related U.S. Application Data
(60) Provisional application No. 62/051,577, filed on Sep. 17, 2014.

(51) Int. Cl. F21V 3/04

(52) U.S. Cl. CPC F21V 3/0436; F21Y 2101/02

(57) ABSTRACT

A lighting device comprising a light emitting diode and a cover comprising an ionomer composition that has improved optical properties. The ionomer composition comprises an ionomer that is produced by partially neutralizing a precursor acid copolymer that has a melt index of about 20 to about 400 g/10 min. The precursor acid copolymer comprises copolymerized units of an α-olefin having 2 to 10 carbons and, based on the total weight of the precursor acid copolymer, about 12 to about 30 weight % of copolymerized units of an α,β-ethylenically unsaturated carboxylic acid having 3 to 8 carbons.

### CROSS-REFERENCE TO RELATED APPLICATION

This application claims priority under 35 U.S.C. §119 to U.S. Provisional Application No. 62/051,577, filed on Sep. 17, 2014, which is incorporated herein by reference in its entirety.

### FIELD OF THE INVENTION

The present invention relates to LED devices with housings or covers comprising molded articles, in particular injection molded or compression molded articles, made from certain ionomer compositions having good optical properties.

### BACKGROUND OF THE INVENTION

Several patents and publications are cited in this description in order to more fully describe the state of the art to which this invention pertains. The entire disclosure of each of these patents and publications is incorporated by reference herein.

A light-emitting diode (LED) can often provide light in a more efficient manner than an incandescent light source and/or a fluorescent light source. The relatively high power efficiency associated with LEDs has created an interest in using LEDs to displace conventional light sources in a variety of lighting applications. For example, in some instances LEDs are being used as traffic lights, to illuminate displays systems and so forth. Furthermore, LEDs are being incorporated into residential and commercial lighting applications displacing less efficient and less durable light devices. Many technological advances have led to the development of high power LEDs by increasing the amount of light emission from such devices.

Examples of LED lighting devices are described in U.S. Pat. Nos. 6,113,248 and 6,568,834.

As LEDs have increasingly become desirable for their long lifespan, efficient energy consumption and durability, a need to configure LED lighting devices to fit and function similar to traditional lighting sources has arisen.

It is also desirable to provide LED devices with housings or covers that protect the components of the LED and associated electronics while providing effective light transmission from the LED.

Ionomers are copolymers produced by partially or fully neutralizing parent acid copolymers comprising copolymerized residues of α-olefins and α,β-ethylenically unsaturated carboxylic acids (see e.g. U.S. Pat. Nos. 3,264,272; 3,344,014 and 3,404,134. A variety of articles made from ionomers by injection molding processes have been used in our daily life.

For example, golf balls with ionomer covers have been produced by injection molding. See, e.g.; U.S. Pat. Nos. 4,714,253; 5,439,227; 5,452,898; 5,553,852; 5,752,889; 5,782,703; 5,782,707; 5,803,833; 5,807,192; 6,179,732; 6,699,027; 7,005,098; 7,128,864; 7,201,672; and U.S. Patent Publications 2006/0043632; 2006/0273485; and 2007/0282069.

Ionomers have also been used to produce injection molded hollow articles, such as containers. See, e.g. U.S. Pat. Nos. 4,857,258; 4,937,035; 4,944,906; 5,094,921; 5,788,890; 6,207,761; and 6,866,158, U.S. Patent Publications 20020180083; 20020175136; and 20050129888, EPO Patent Nos. EP1816147 and EP0855155, and PCT Patent Publications WO2004062881; WO2008010597; and WO2003045186.

High clarity ionomers have been described in U.S. Pat. Nos. 7,351,468; 7,678,441; 7,763,360; 7,951,865 and U.S. Patent Application Publication 2009297747.

Articles produced by injection molding often have relatively thick wall structures, including housings or covers for LED devices. When ionomers are used in forming such articles, the optical properties tend to suffer due to the thickness of the wall. There is a need to develop LED devices made of ionomer compositions that have good optical properties and melt flow rates useful for injection molding.

### SUMMARY OF THE INVENTION

The invention provides a lighting device comprising a light emitting diode and a molded cover comprising, consisting essentially of, or prepared, from an ionomer that is produced by partially neutralizing a precursor acid copolymer, and the precursor acid copolymer comprises copolymerized units of an α-olefin having 2 to 10 carbons and, based on the total weight of the precursor acid copolymer, about 12 to about 30 weight % of copolymerized units of an α,β-ethylenically unsaturated carboxylic acid having 3 to 8 carbons; wherein the precursor acid copolymer has a melt flow rate (MFR) of about 200 g/10 min to about 400 g/10 min, as determined in accordance with ASTM D 1238 at 190° C. and under a weight of 2.16 kg; about 5% to about 90% of the total carboxylic acid content of the precursor acid copolymer is neutralized; and wherein the ionomer has a MFR of about 2 g/10 min to about 25 g/10 min, as determined in accordance with ASTM D-1238 at 190° C. and under a weight of 2.16 kg.

Notable ionomers useful in the LED device are those wherein haze of the ionomer composition is from about 0.5 to 13.5, when measured according to ASTM-1003 ASTM D1003 on a test plaque having a thickness of 3.0 mm, said test plaque made by melting the ionomer composition, forming the molten ionomer composition into the test plaque, and cooling the molten ionomer composition to a temperature of (22±3° C.) or less at a rate of 0.7° C./min or less.

The invention also provides a method for preparing a lighting device comprising
(a) preparing a cover comprising an ionomer that is produced by partially neutralizing a precursor acid copolymer, and the precursor acid copolymer comprises copolymerized units of an α-olefin having 2 to 10 carbons and, based on the total weight of the precursor acid copolymer, about 12 to about 30 weight % of copolymerized units of an α,β-ethylenically unsaturated carboxylic acid having 3 to 8 carbons; wherein the precursor acid copolymer has a melt flow rate (MFR) of about 200 g/10 min to about 400 g/10 min, as determined in accordance with ASTM D 1238 at 190° C. and under a weight of 2.16 kg; about 5% to about 90% of the total carboxylic acid content of the precursor acid copolymer is neutralized; and wherein the ionomer has a MFR of about 2 g/10 min to about 25 g/10 min, as determined in accordance with ASTM D-1238 at 190° C. and under a weight of 2.16 kg; by extrusion molding, blow molding, compression molding or injection molding;
(b) providing a light emitting diode; and
(c) combining the cover and the light emitting diode.

### DETAILED DESCRIPTION OF THE INVENTION

The following definitions apply to the terms as used throughout this specification, unless otherwise limited in specific instances.

The technical and scientific terms used herein have the meanings that are commonly understood by one of ordinary skill in the art to which this invention belongs. In case of conflict, the present specification, including the definitions herein, will control.

As used herein, the terms “comprises,” “comprising,” “includes,” “including,” “containing,” “characterized by,” “has,” “having” or any other variation thereof, refer to a non-exclusive inclusion. For example, a process, method, article, or apparatus that comprises a given list of elements is not necessarily limited to only those elements given, but may further include other elements not expressly listed or inherent to such process, method, article, or apparatus.

The transitional phrase “consisting of excludes any element, step, or ingredient not specified in the given list of elements, closing the list to the inclusion of materials other than those recited except for impurities ordinarily associated therewith. When the phrase “consists of” appears in a clause of the body of a claim, rather than immediately following the preamble, it limits only the element set forth in that clause; other elements are not excluded from the claim as a whole.

The transitional phrase “consisting essentially of” limits the scope of a claim to the specified materials or steps and those that do not materially affect the basic and novel characteristic(s) of the claimed invention. A ‘consisting essentially of’ claim occupies a middle ground between closed claims that are written in a ‘consisting of’ format and fully open claims that are drafted in a ‘comprising’ format. Optional additives as defined herein, at levels that are appropriate for such additives, and minor impurities are not excluded from a composition by the term “consisting essentially of”.

When a composition, a process, a structure, or a portion of a composition, a process, or a structure, is described herein using an open-ended term such as “comprising,” unless otherwise stated the description also includes an embodiment that “consists essentially of” or “consists of” the elements of the composition, the process, the structure, or the portion of the composition, the process, or the structure.

The articles “a” and “an” may be employed in connection with various elements and components of compositions, processes or structures described herein. This is merely for convenience and to give a general sense of the compositions, processes or structures. Such a description includes “one or at least one” of the elements or components. Moreover, as used herein, the singular articles also include a description of a plurality of elements or components, unless it is apparent from a specific context that the plural is excluded.

The term “or”, as used herein, is inclusive; that is, the phrase “A or B” means “A, B, or both A and B”. More specifically, a condition “A or B” is satisfied by any one of the following: A is true (or present) and B is false (or not present); A is false (or not present) and B is true (or present); or both A and B are true (or present). Exclusive “or” is designated herein by terms such as “either A or B” and “one of A or B”, for example.

The term “about” means that amounts, sizes, formulations, parameters, and other quantities and characteristics are not and need not be exact, but may be approximate and/or larger or smaller, as desired, reflecting tolerances, conversion factors, rounding off, measurement error and the like, and other factors known to those of skill in the art. In general, an amount, size, formulation, parameter or other quantity or characteristic is “about” or “approximate” whether or not expressly stated to be such.

In addition, the ranges set forth herein include their endpoints unless expressly stated otherwise. Further, when an amount, concentration, or other value or parameter is given as a range, one or more preferred ranges or a list of upper preferable values and lower preferable values, this is to be understood as specifically disclosing all ranges formed from any pair of any upper range limit or preferred value and any lower range limit or preferred value, regardless of whether such pairs are separately disclosed. The scope of the invention is not limited to the specific values recited when defining a range.

When materials, methods, or machinery are described herein with the term “known to those of skill in the art”, “conventional” or a synonymous word or phrase, the term signifies that materials, methods, and machinery that are conventional at the time of filing the present application are encompassed by this description. Also encompassed are materials, methods, and machinery that are not presently conventional, but that will have become recognized in the art as suitable for a similar purpose.

Unless stated otherwise, all percentages, parts, ratios, and like amounts, are defined by weight.

As used herein, the term “copolymer” refers to polymers comprising copolymerized units resulting from copolymerization of two or more comonomers. In this connection, a copolymer may be described herein with reference to its constituent comonomers or to the amounts of its constituent comonomers, for example “a copolymer comprising ethylene and 9 weight % of acrylic acid”, or a similar description. Such a description may be considered informal. As used herein, however, a description of a copolymer with reference to its constituent comonomers or to the amounts of its constituent comonomers means that the copolymer contains copolymerized units (in the specified amounts when specified) of the specified comonomers.

The term “dipolymer” refers to polymers consisting essentially of two monomers and the term “terpolymer” refers to polymers consisting essentially of three monomers.

The term “acid copolymer” refers to a polymer comprising copolymerized units of an α-olefin, an α,β-ethylenically unsaturated carboxylic acid, and optionally other suitable comonomer(s), such as an α,β-ethylenically unsaturated carboxylic acid ester.

The term “ionomer” refers to a polymer that is produced by partially or fully neutralizing the carboxylic acid groups of an acid copolymer.

The term “(meth)acrylic acid,” and the abbreviation “(M)AA,” refers to methacrylic acid, acrylic acid, or a combination of methacrylic acid and acrylic acid. Likewise, the terms “(meth)acrylate” and “alkyl(meth)acrylate” refer to alkyl esters of methacrylic acid, acrylic acid, or a combination of methacrylic acid and acrylic acid.

Described herein is a molded article useful as a cover or housing for a LED lighting device produced from an ionomer composition having good optical properties, i.e., lower haze and higher clarity, and melt flow rates suitable for injection molding.

A LED lighting device comprises an LED, electrical components that connect to an electrical power source and various housing elements, including a cover protecting the LED that allows the light to pass through. The cover may be configured in a variety of shapes depending on the application, including flat portions, facets, or curved portions. In some cases, the housing, including the cover, is shaped to emulate a bulb shape similar to that of an incandescent light bulb. Further, the cover may have a complex shape. For example, some portions of the cover may be relatively thin and designed for the light from the LED to pass through, while other portions are thicker and designed to provide strength to the cover and/or shaped to provide attachment regions for attaching the cover to the other components of the LED device.

The cover may be used in shaping the output of light emitted from LED. This cover may also be coated or otherwise implanted with a phosphor or other color converting mechanism to help create a different monochromatic or polychromatic emission than the original emission produced from LED.

The cover can be clear or it can contain color. It may also be translucent, depending upon the formulation and method of production. The specific dimension of any cover will vary with the application. It should be obvious that the cover can be made to any shape and size. More than one LED may be used as a light source if the face of the device is large or if higher intensity light is desired. Since the normal LED is small, a cover having its largest dimension up to about 4 inches or about 10 cm would be satisfactory to cover the emitted light from the LED.

The spatial relationship of the cover and the light source may vary. The cover may be spaced from the light source, as is the common design of typical incandescent lights and associated lenses. Alternatively, the light source can be placed against or in contact with the cover. An extension of this design is embedding the light source in the cover material. The LED light source lends itself well to this arrangement since it is small and gives off negligible heat.

The cover described in this application is useful for numerous different kinds of LEDs. When the LED itself is not circular in its upper dimension the cover described herein can be molded in different forms so that it is useful with any kind of an LED. The cover may be shaped or molded into any number of desired shapes. Also, the LED may be placed anywhere within or at the surface of the cover.

The cover is made from a plastic material comprising an ionomer, particularly one designed for injection molding applications. Although the articles provided herein may be formed by any type of molding, such as extrusion molding, blow molding, injection stretch blow molding, compression molding or injection molding, the articles are described for the most part in terms of injection molding. Because ionomer compositions are typically thermoplastic materials, it is believed that injection molding will be the most commonly used process for forming the articles. Alternatively, the cover may be prepared by thermoforming, such as plug-assist thermoforming or vacuum thermoforming.

The ionomer composition used in the injection molded article comprises an ionomer whose precursor acid copolymer comprises copolymerized units of an α-olefin having 2 to 10 carbons and, based on the total weight of the acid copolymer, about 12 to about 30 weight %, or about 15 to about 30 weight %, or about 19 to about 30 weight %, or about 19 to about 21 weight %, or about 19.5 to about 25 weight %, or about 21 to about 23 weight % of copolymerized units of an α,β-ethylenically unsaturated carboxylic acid having 3 to 8 carbons. Notable acid copolymers include about 15 to about 19 weight % of copolymerized units of an α,β-ethylenically unsaturated carboxylic acid.

Suitable α-olefin comonomers include, but are not limited to, ethylene, propylene, 1-butene, 1-pentene, 1-hexene, 1-heptene, 3 methyl-1-butene, 4-methyl-1-pentene, and the like and mixtures of two or more thereof. Preferably, the α-olefin is ethylene.

Suitable α,β-ethylenically unsaturated carboxylic acid comonomers include, but are not limited to, acrylic acid, methacrylic acid, itaconic acid, maleic acid, maleic anhydride, fumaric acid, monomethyl maleic acid, and mixtures of two or more thereof. Preferably, the α,β-ethylenically unsaturated carboxylic acid is (meth)acrylic acid.

The precursor acid copolymer may further comprise copolymerized units of one or more other comonomer(s), such as unsaturated carboxylic acids having 2 to 10 carbons, or preferably 3 to 8 carbons, or derivatives thereof. Suitable acid derivatives include acid anhydrides, amides, and esters. Esters are preferred. Specific examples of preferred esters of unsaturated carboxylic acids include, but are not limited to, methyl acrylates, methyl methacrylates, ethyl acrylates, ethyl methacrylates, propyl acrylates, propyl methacrylates, isopropyl acrylates, isopropyl methacrylates, butyl acrylates, butyl methacrylates, isobutyl acrylates, isobutyl methacrylate, tert-butyl acrylates, tert-butyl methacrylates, octyl acrylates, octyl methacrylates, undecyl acrylates, undecyl methacrylates, octadecyl acrylates, octadecyl methacrylates, dodecyl acrylates, dodecyl methacrylates, 2-ethylhexyl acrylates, 2-ethylhexyl methacrylates, isobornyl acrylates, isobornyl methacrylates, lauryl acrylates, lauryl methacrylates, 2-hydroxyethyl acrylates, 2-hydroxyethyl methacrylates, glycidyl acrylates, glycidyl methacrylates, poly(ethylene glycol)acrylates, poly(ethylene glycol)methacrylates, poly(ethylene glycol)methyl ether acrylates, poly(ethylene glycol)methyl ether methacrylates, poly(ethylene glycol)behenyl ether acrylates, poly(ethylene glycol)behenyl ether methacrylates, poly(ethylene glycol) 4-nonylphenyl ether acrylates, poly(ethylene glycol) 4-nonylphenyl ether methacrylates, poly(ethylene glycol)phenyl ether acrylates, poly(ethylene glycol)phenyl ether methacrylates, dimethyl maleates, diethyl maleates, dibutyl maleates, dimethyl fumarates, diethyl fumarates, dibutyl fumarates, dimethyl fumarates, vinyl acetates, vinyl propionates, and mixtures of two or more thereof. Examples of preferable suitable comonomers include, but are not limited to, methyl acrylates, methyl methacrylates, butyl acrylates, butyl methacrylates, glycidyl methacrylates, vinyl acetates, and mixtures of two or more thereof.

The precursor acid copolymer may be synthesized as described in U.S. Pat. Nos. 3,404,134; 5,028,674; 6,500,888; and 6,518,365. Some suitable precursor acid copolymers may also be available from E.I. du Pont de Nemours & Co. of Wilmington, Del. (hereinafter “DuPont”) under the Nucrel® trademark.

Suitable precursor acid copolymers have a melt flow rate (MFR or MI) of about 200 to about 400 g/10 min, about 200 to about 350 g/10 min, about 200 to about 300 g/10 min. Alternatively, the precursor acid copolymers have a melt flow rate (MFR or MI) of 200 g/10 min or less, 150 g/10 min or less, 100 g/10 min or less, 70 g/10 min or less, or 45 g/10 min or less, such as from about 20 to about 60 g/10 min or about 50 to about 70 g/10 min or less, as determined by ASTM D-1238 at 190° C. and 2.16 kg.

To produce the ionomer used in the ionomer composition, the carboxylic acid groups in the precursor acid copolymer are neutralized to form carboxylate anions. Preferably, about 5% to about 90%, or preferably about 10% to about 50%, or more preferably about 20% to about 50%, or about 20% to about 40% of the carboxylic acid groups are neutralized, based on the total carboxylic acid content of the precursor acid copolymer prior to the neutralization.

The ionomer further comprises, as counterions to the carboxylate groups, one or more cations. Preferably, the cations are metal ions. The metal ions may be monovalent, divalent, trivalent, multivalent, or a combination of ions of different valencies. Useful monovalent metal ions include but are not limited to ions of sodium, potassium, lithium, silver, mercury, copper, and the like, and mixtures of two or more thereof. Useful divalent metal ions include but are not limited to ions of beryllium, magnesium, calcium, strontium, barium, copper, cadmium, mercury, tin, lead, iron, cobalt, nickel, zinc, and the like, and mixtures of two or more thereof. Useful trivalent metal ions include but are not limited to ions of aluminum, scandium, iron, yttrium, and the like, and mixtures of two or more thereof. Useful multivalent metal ions include but are not limited to ions of titanium, zirconium, hafnium, vanadium, tantalum, tungsten, chromium, cerium, iron, and the like, and mixtures of two or more thereof. It is noted that when the metal ion is multivalent, complexing agents such as stearate, oleate, salicylate, and phenolate radicals may be included, as described in U.S. Pat. No. 3,404,134. The metal ions are preferably monovalent or divalent. More preferably, the metal ions are selected from the group consisting of sodium, lithium, magnesium, zinc, potassium and mixtures of two or more thereof. Yet more preferably, the metallic ions are sodium, zinc, or sodium and zinc. Sodium ions are particularly preferred. The precursor acid copolymers may be neutralized by procedures described in U.S. Pat. No. 3,404,134.

Suitable ionomers have a MFR of about 3 g/10 min to about 25 g/10 min, or about 4 to about 20 g/10 min, as determined by ASTM D-1238 at 190° C. and 2.16 kg. Some preferred ionomers have a melt index in the range of 10 to 20 g/10 min. Alternatively, suitable ionomers have MFR of about 1g/10 min to about 3 g/10 min, particularly those wherein the parent acid copolymer comprises from about 20 to about 23 weight % of copolymerized units of carboxylic acid moieties.

The ionomer composition may further comprise one or more suitable additive(s). Suitable additives include, but are not limited to, plasticizers, processing aides, flow enhancing additives, flow reducing additives (e.g., organic peroxides), lubricants, pigments, dyes, optical brighteners, flame retardants, impact modifiers, nucleating agents, antiblocking agents (e.g., silica), thermal stabilizers, hindered amine light stabilizers (HALS), UV absorbers, UV stabilizers, dispersants, surfactants, chelating agents, coupling agents, adhesives, primers, reinforcement additives (e.g., glass fiber), fillers, and the like, and combinations of two or more additives. Suitable levels of these additives and methods of incorporating these additives into polymer compositions will be known to those of skill in the art. See, e.g., the Modern Plastics Encyclopedia, McGraw-Hill (New York, N.Y., 1995).

Three preferred additives include thermal stabilizers, UV absorbers, and hindered amine light stabilizers. Thermal stabilizers have been described in the art. Preferred general classes of thermal stabilizers include, but are not limited to, phenolic antioxidants, alkylated monophenols, alkylthiomethylphenols, hydroquinones, alkylated hydroquinones, tocopherols, hydroxylated thiodiphenyl ethers, alkylidenebisphenols, O-, N- and S-benzyl compounds, hydroxybenzylated malonates, aromatic hydroxybenzyl compounds, triazine compounds, aminic antioxidants, aryl amines, diaryl amines, polyaryl amines, acylaminophenols, oxamides, metal deactivators, phosphites, phosphonites, benzylphosphonates, ascorbic acid (vitamin C), compounds that destroy peroxide, hydroxylamines, nitrones, thiosynergists, benzofuranones, indolinones, and the like and mixtures thereof. The ionomer compositions may contain any effective amount of thermal stabilizer(s). Use of thermal stabilizer(s) is optional and in some instances is not preferred. When thermal stabilizer(s) are used, they may be present in the ionomer compositions at a level of at least about 0.05 weight %, and up to about 10 weight %, more preferably up to about 5 weight %, and still more preferably up to about 1 weight %, based on the total weight of the ionomer composition.

UV absorbers have also been described in the art. Preferred general classes of UV absorbers include, but are not limited to, benzotriazoles, hydroxybenzophenones, hydroxyphenyl triazines, esters of substituted and unsubstituted benzoic acids, and the like and mixtures thereof. The ionomer compositions may contain any effective amount of UV absorber(s). Use of an UV absorber is optional and in some instances is not preferred. When UV absorber(s) are used, they may be present in the ionomer compositions at a level of at least about 0.05 weight %, and up about 10 weight %, more preferably up to about 5 weight %, and still more preferably up to about 1 weight %, based on the total weight of the ionomer composition.

Hindered amine light stabilizers have also been described in the art. Generally, hindered amine light stabilizers are secondary or tertiary, acetylated, N-hydrocarbyloxy substituted, hydroxy substituted N-hydrocarbyloxy substituted, or other substituted cyclic amines which further incorporate steric hindrance, generally derived from aliphatic substitution on the carbon atoms adjacent to the amine function. The ionomer compositions may contain any effective amount of hindered amine light stabilizer(s). Use of a hindered amine light stabilizer is optional and in some instances is not preferred. When hindered amine light stabilizer(s) are used, they may be present in the ionomer compositions at a level of at least about 0.05 weight %, and up to about 10 weight %, more preferably up to about 5 weight %, and still more preferably, up to about 1 weight %, based on the total weight of the ionomer composition.

The injection molded articles have a minimum thickness of at least about 0.3 mm. Preferably, the injection molded article has a substantially uniform thickness in the area where light is to pass through, that is, preferably the minimum thickness and the maximum thickness are in the range of about 0.3 to about 25 mm, about 0.3 to about 10 mm, about 0.3 to about 5 mm, or about 0.5 to about 3.5 mm.

In this connection, the term “thickness” as used herein refers to the length of an object in its smallest dimension. For example, when the object is a cover for an LED device, the “thickness” is typically the distance measured through the wall of the cover in a direction that is perpendicular to the wall. More particularly, if the article is a cylinder with a height of 10 cm, concentric inner and outer circumferences, an inner diameter of 9 cm and an outer diameter of 10 cm, then the thickness of the article is 0.5 cm. If a cover is made by combining this cylinder with a “top” that is a disk having a diameter of 10 cm and a thickness of 1.0 cm, then the minimum thickness of the container is 0.5 cm and its maximum thickness is 1.0 cm or possibly slightly greater than 1.0 cm in the corner where the cylinder meets the container bottom.

As is noted above, any suitable molding process may be used to form the molded articles described herein. Injection molding is a preferred molding process. The molded articles described herein may preferably be produced by any suitable injection molding process. Suitable injection molding processes include co-injection molding and over-molding. These processes are also referred to as two-shot or multi-shot molding processes.

Injection molding equipment and processes are described generally in the Modern Plastics Encyclopedia and in the Kirk-Othmer Encyclopedia of Chemical Technology (5^{th} Edition), Wiley-Interscience (Hoboken, N.J., 2006). In addition to this information, some manufacturers of injection molding equipment also provide instruction in injection molding techniques. With these resources at hand, one skilled in the art is able to determine the proper molding conditions required to produce a particular type of article from a given ionomer composition.

In general, however, an injection molding process may comprise the steps of:
melting the ionomer composition;
forming the injection molded article by flowing the molten ionomer composition into a mold;
cooling the injection molded article in the mold until it will hold its shape;
releasing the injection molded article from the mold; and
cooling the injection molded article to room temperature (22±3° C.) or to a lower temperature.

As those of skill in the art are aware, injection molded articles, when removed from their molds, must have sufficient stability to hold their shape when subjected without mechanical support to the force of gravity. In addition, articles such as those described herein, which may have some appreciable thickness, may not have a uniform temperature throughout their bulk. Rather, the temperature of the surface of the newly unmolded (released from the mold) article will be approximately equal to that of the mold, and its internal temperature will be significantly higher. In fact, the surface of the object may have a temperature that is below the solidification temperature of the ionomer composition, and the core of the article may have a temperature that is above the solidification temperature.

Moreover, although the temperature external to the article may be controlled so that the environment is cooled at a particular rate, the rate at which the article actually cools, both in its interior and at its surface, is limited by the rate of heat transfer through the article and from the article's surface to its surroundings (typically air or quench bath). Consequently, the cooling rate of the articles described herein may not be uniform. The rate may be different at the article's surface than it is at the article's core, and the rate may vary continuously or discontinuously. For example, it may decrease with time approximately as an exponential function, when the temperature of the heat sink or environment is held approximately constant. The principles of heat transfer that govern the cooling of the articles are well understood and are summarized in references such as Holman, J., Heat Transfer, McGraw-Hill (New York, 2009).

More specifically, however, the ionomer composition is generally molded (flowed into the mold) at a melt temperature of about 120° C. to about 250° C., or preferably about 130° C. to about 210° C. In general, slow to moderate fill rates with pressures of about 40 to about 140 MPa are used. The mold temperatures may be in the range of about 5° C. to about 50° C. The injection molded article is cooled in the mold until it is self-supporting, as described above. Its surface temperature may be in the range of the temperature of the mold to a temperature that is below the solidification temperature of the ionomer composition when it is released from the mold. The bulk or average temperature of the article may be about 70° C. to about 80° C. The temperature in the interior of the article may range from the temperature of the mold to temperatures above the melting temperature of the ionomer composition. Indeed, the interior temperature of the newly ejected article may be close to the temperature of the ionomer composition melt that was flowed into the mold. Finally, the injection molded article is cooled to room temperature, with or without quenching, at a rate of about 2.0° C./min, 1.5° C./min, 1.0° C./min, 0.7° C./min, 0.5° C./min, 0.3° C./min, 0.2° C./min, 0.1° C./min or less, or at a rate that varies continuously or discontinuously between 2.0° C./min and 0.1° C./min. These cooling rates may refer to the temperature of the environment or heat sink, as in the example of a programmable oven or a temperature-controlled bath. Alternatively, they may refer to the bulk (average) temperature or core temperature of the article. Clearly, the article's surface may cool at much higher rates than these, for example up to about 50° C./min in the case of a molded article ejected from a mold into an ice water bath.

The ionomer compositions described above surprisingly provide molded articles with good toughness and optical properties. The good optical properties are distinctly evidenced when the articles are subjected to lower cooling rates. During the final steps of a molding process, for example, the molded article is ejected from the mold. The article may then be quenched, for example in a cool water bath. Because of the relatively lower temperature of the water and the relatively good heat transfer properties of water, quenched articles are expected to cool to room temperature over a relatively shorter time. Quenching requires additional equipment and a more elaborate manufacturing procedure, however.

Alternatively, the newly ejected article may be placed on a cooling station (such as a cart or a tabletop in the manufacturing facility) to cool to room temperature (22±3° C.). In practice, as several of the hot, newly unmolded articles may be placed on the cooling station, the temperature of the air immediately surrounding the cooling station may be significantly higher than room temperature. Because of the relatively higher temperature and the relatively poor heat transfer properties of air, these articles are expected to cool to room temperature over a relatively longer time. Consequently, good optical properties under slow cooling rates may be desirable attributes of molded articles used for lighting device covers.

In this connection, it is known that polyethylene and polymers comprising a significant amount of copolymerized ethylene tend to crystallize upon cooling from the melt, and that lower cooling rates favor the formation of more and larger crystals. Crystals above a certain size will contribute to a hazy appearance or a lack of clarity in polyethylenes and ethylene copolymers, even if the crystals are too small to be visible to the unaided eye. Without wishing to be held to any theory, it is postulated that the ionomer compositions described herein have a lower level of crystallinity, crystal mass or crystal size, such that the molded articles have superior optical properties even when they are cooled under conditions that favor crystallization.

In particular, the ionomer compositions described herein have a haze ranging from 0.7 to 13.5, 1.0 to 12.0, 2.0 to 10.0, 3.0 to 9.0, or 4.0 to 8.0, when measured according to ASTM D1003 using a Haze-gard Plus hazemeter (BYK-Gardner, Columbia, Md.) on a test plaque having a thickness of 3.0 mm, said test plaque made by melting the ionomer composition, forming the molten ionomer composition into the test plaque, and cooling the molten ionomer composition to a temperature of (22±3° C.) or less at a rate of 0.7° C./min or less.

The clarity may be measured quantitatively, for example using the Haze-gard Plus hazemeter. Alternatively, the optical properties may be observed with the unaided eye and reported semi-quantitatively (e.g., compared to a set of standards of known clarity), qualitatively or in a relative ranking.

Although high clarity and transparency is desired, in some LED lighting applications it may be desired to provide a cover with a matte or translucent look, so that the light from the LED is scattered to provide a soft light. Light from a LED is generally monodirectional, so it may be desirable to scatter the light to make it more omnidirectional. In such cases, the ionomer may be mixed with a hydrocarbon material to create a matte look. Broad ranges of hydrocarbons can be used for this purpose. Alternatively, the cover comprising the ionomer may be coated on the interior and/or the exterior relative to the LED to provide the translucent effect. Even with such translucent modifications, the basic clarity of the ionomer composition as described herein is desirably high so that light from the LED is transmitted out of the device at the maximum efficiency consistent with the design of the device.

When translucent covers are desired, ionomers with less intrinsic clarity but higher thermal properties (resistance to deformation under heating) may be useful. Such ionomers include those wherein the parent acid copolymer has from about 15 to about 19 weight % of copolymerized acid monomers.

The molded article may have any form. For example, the molded article may be in the form of a multi-layer structure (such as an over-molded article), wherein at least one layer of the multi-layer structure consists essentially of the ionomer composition described above and has a minimum thickness of at least about 0.3 mm. Preferably, the ionomer layer of the multi-layer article has a thickness of about 0.3 to about 10 mm, about 0.3 to about 5 mm, or about 0.5 to about 3.5 mm.

The article may be an intermediate article for use in further shaping processes. For example, the injection molded article may be a pre-form or a parison suitable for use in a blow molding process.

A preform or parison is a substantially tubular hollow article having a closed end and an open end having relatively thick walls that is adapted for subsequent blow molding into a finally desired shape. The molding may be such that various flanges and protrusions (the “finish”) at the open end provide strengthening ribs and/or closure means, for example screw threads, snap fittings or other means for attaching the cover to the other parts of the lighting device.

In blow molding, the initially formed preform with wall thickness greater than that desired for the final thickness is softened by heating above its softening point, and the softened preform is inflated with air pressure to conform to a mold whose inner cavity provides the final outer shape of the blow molded article. The resulting blow molded article has thinner wall thickness than the original preform. Blow-molding processes may be used to form covers for LED devices that may be in the form of bulbs, cylinders, domes or any shape that is generally convex when placed over the LED in the LED lighting device. The injection molded intermediate article may be in the form of a multi-layer structure. Thus, the cover produced will also have a multi-layer wall structure.

Injection stretch blow molding is similar, except that the finish end of the parison is injection molded and the rest of the parison is blow molded to its final shape in a single machine while the parison is still in a softened state.

Thermoforming involves forming a flat sheet into an article having a convex shape typically by heating the amorphous flat sheet to above the glass transition temperature (Tg) and below the melting point of the plasticized polymer composition, stretching the sheet by vacuum or pressure forming using a mold to provide a stretched article, and cooling the stretched article to provide a finished article. The stretched article may be optionally heat treated to provide greater crystallization.

For example, the compositions may be formed into films or sheets by extrusion through either slot dies and rapidly cooled by contact with metal rolls held at or below Tg to produce a first article including film or sheet or blown film or sheet. The first film or sheet article can be thermoformed in a mold at a temperature of at least about 90° C., at least about 95° C., at least about 100° C. or at least about 120° C. and may be up to about 140° C., to produce a second article. The second article is held in the heated mold for less than about 40, less than about 20 seconds, less than about 10 seconds, or less than about 5 seconds to produce a thermoformed article that has the shape desire for the cover of the lighting device.

The mold material can be aluminum or ceramic and can be used for stretching (orientation) the heated sheet of the ionomer composition to conform the sheet to the shape of the mold. Thermoforming can be facilitated by vacuum-assist (application of vacuum from inside the mold to a heated sheet covering the top of the mold), pressure-assist (application of pressurized air to the sheet covering the top of the mold) and/or plug-assist (mechanically pressing the sheet into the mold) techniques.

Also preferred are those articles that are in the form of a multi-layer structure, in which at least one layer consists essentially of the ionomer composition and has a minimum thickness of at least about 0.3 mm.

The excellent optical properties under slower cooling rates afforded by the compositions described herein are particularly desirable for covers of LED devices.

When the article is produced by an over-molding process, the ionomer composition may be used as the substrate material, the over-mold material or both. An overmolded structure may be useful when the superior clarity and shine afforded by the ionomer composition are desired in a surface layer. For example, when an over-molding process is used, the ionomer composition described herein may be over-molded on other articles such as components of an LED lighting device to form a protective overcoat that allows light from the LED to pass through. A representative overmolding process is described in U.S. Patent Application Publication 2011/0115134.

The lighting device may further comprise a base wherein said base is attached to the cover, forming a bulb, and the light emitting diode is electrically connected to the base and contained within the bulb. The base may also include various electrical and electronic components, such as for example, voltage and/or current modifiers, switches and the like tom allow the LED to function as a light source. A portion of the lighting device, for example the base, may be configured to provide an electrical connection to a power source for powering the LED. The base may be configured with screw threads, prongs, contacts, projections and the like to provide electrical connection to a power source by making contact with a complementary-shaped socket or contact connected with a power source, including a battery, generator or an alternating current source.

The method for preparing a lighting device comprises
(a) preparing a cover comprising an ionomer as described above; by extrusion molding, blow molding, compression molding, thermoforming, or injection molding;
(b) providing a light emitting diode; and
(c) combining the cover and the light emitting diode.

The method may further comprise combining the cover and the LED with a base. The following examples are provided to describe the invention in further detail. These examples, which set forth a preferred mode presently contemplated for carrying out the invention, are intended to illustrate and not to limit the invention.

### EXAMPLES

### Material and Methods

### Melt Flow Rates

The melt flow rates (MFR or MI) were measured according to ASTM Standard No. D-1238, at 190° C. and under a weight of 2.16 kg.

### Injection Molding

Injection molded rectangular test bars with the dimensions of 125×75×3 mm (thin test bars) and 125×45×20 mm (thick test bars) were made by feeding the ionomer resins into a Model 150-6 HPM injection molding machine (available from Taylor's Industrial Services of Mount Gilead, Ohio). The ionomer melt temperature was in the range of 130° C. to 200° C. and the mold was maintained at a temperature of about 10° C. The mold cycle time was approximately 90 seconds. Both the thin and thick test bars were obtained by ejecting the molded bars from the mold and cooling them under ambient conditions to room temperature (about 22±3° C.). For the thick test bars, the “air cooled” cooling rate was estimated to be about 0.3° C./min in the first hour after unmolding, and the rate was estimated to approach about 0.1° C./min at longer times.

After the haze level was measured, the “air cooled” thin test bars were re-heated in an air oven (at a temperature of 125° C.) for 90 min and then cooled at a rate of 0.1° C./min to room temperature to produce the “slow cooled” test bars.

### Haze Measurements

Using a HunterLab ColorQuest XE haze meter (Hunter Associates Laboratory, Inc., Reston, Va.), the haze level of the “air cooled” and “slow cooled” thin test bars was measured through their 3 mm thick dimension in accordance with ASTM D1003-07.

### Clarity Measurements

The clarity of the thick test bars was determined by visual inspection. The bars were ranked on a relative scale from 1 (highest clarity) to 3 (lowest clarity).

Stress Crack Testing of Injection Molded parts Ionomers were injection molded into long bars (180 mm×27 mm×2 mm) parts on an NETSTAL 1 Synergy 1750H-460 molding apparatus. The polymer melt temperature ranged from 130 to 200° C. The mold temperature was maintained at approximately 20° C., and the cycle time was approximately 40 seconds. The test bars were cooled at room temperature at a rate of approximately 10° C./min.

The molded bars were folded in half)(180° and placed in a sample holder at 23° C. Two levels of stress were applied. The stress level was designated “medium” when the distance between the two ends of the folded test bar was maintained at 45 mm. The stress level was designated “high” when the two ends of the folded test bar touched and a separation of 5 mm was maintained 10 mm from the top of the fold.

### Ionomer Resins

Table 1 summarizes the ionomers used herein. Table 2 summarizes the properties of the ionomers.

TABLE 1

| | | | | MI (g/10 min) | |
|---|---|---|---|---|---|
| Resin | % MAA | % Na | % Neutralization | Base polymer | Ionomer |
| A | 15 | 2.25 | 56 | 60 | 0.9 |
| B | 15 | 2.05 | 51 | 225 | 4.5 |
| C | 19 | 2.5 | 49 | 315 | 4.5 |
| D | 21.7 | 1.51 | 26 | 25 | 1.8 |
| E | 19 | 2.2 | 43 | 375 | 9 |
| F | 19 | 2.0 | 39 | 375 | 12 |
| G | 19.8 | 1.8 | 34 | 315 | 15 |
| H | 19 | 1.8 | 35.5 | 375 | 18 |
| I | 19 | 1.9 | 37 | 60 | 2.6 |
| J | 21-23 | 1.5-1.6 | 26 | 245 | |

TABLE 2

| Resin | ASTM Method | A | B | C | D | E | F | G | H |
|---|---|---|---|---|---|---|---|---|---|
| Physical | | | | | | | | | |
| Density (g/cm³) | D792 | 0.95 | 0.96 | 0.97 | 0.96 | | | | |
| Melt Flow (g/10 min) | D1238 | 0.9 | 4.5 | 4.5 | 1.8 | 9 | 12 | 15 | 18 |
| Ultimate Tensile Stress (Kpsi) | D638 | 5.2 | 3.9 | 4.5 | 6.2 | 4.4 | 4.1 | 4.2 | 4.0 |
| Elongation at Break (%) | D638 | 302 | 261 | 221 | 273 | 242 | 227 | 241 | 230 |
| Yield Stress (Kpsi) | D638 | 2.3 | 2.3 | 2.9 | 3.4 | 3.0 | 3.0 | 3.1 | 3.0 |
| Flex Modulus (Kpsi) | D790 | 43.4 | 47.2 | 64.3 | 83.3 | 67.8 | 64.5 | 67.1 | 62.4 |
| Shore D hardness | D2240 | 60 | 60 | 64 | 66 | 66 | 64 | 65 | 64 |
| Thermal | | | | | | | | | |
| Melting Point (° C.) | D3417 | 90 | 91 | 83 | 84 | 83 | 83 | 83 | 82 |
| Vicat Softening Point (° C.) | | 63 | 61 | 49 | 50 | 49 | 49 | 49 | 49 |
| Optical | | | | | | | | | |
| Haze (%) as molded | D1003 | 1.03 | 2.23 | 1.2 | 1.47 | 1.1 | 1.1 | 1.23 | 1.27 |
| Transmission (%) as molded L* | D1003 | 96.74 | 96.54 | 96.87 | 96.8 | 96.84 | 96.99 | 96.86 | 96.83 |
| Haze (%) [0.7° C./min cool] | D1003 | 18 | 33.9 | 0.5 | 2.2 | 1.5 | 2.2 | 3.1 | |
| Injection Molding | | | | | | | | | |
| Melt Temperature (° C.) | | 200-230 | 180-210 | 180-210 | 200-230 | 160-190 | 150-180 | 150-180 | 150-180 |

The results of Table 2 show that ionomers B, C, E, F, G and H with higher melt flows (>than 200 g/10 min) had good properties for injection molding with lower melt processing temperatures needed than for low melt flow ionomers A and D. High acid (19-23% methacrylic acid), high melt flow ionomers C, E, F, G and H had very good haze values, particularly when cooled at 0.7° C./min, compared to ionomers with lower acid levels. These ionomers also had lower Vicat softening points and better yield stress.

Thin and thick injection molded test bars were made from the ionomers listed above, by the molding processes described above. The haze and clarity of these test bars were determined as described above and the results are reported in Table 3.

These results demonstrate that the test bars of Example E1 exhibit higher clarity and lower haze, especially under a slow cooling rate, compared to the test bars of Comparative Examples CE1 and CE2. Moreover, the high acid, high melt flow ionomers also demonstrated better resistance to cracking under high stress conditions.

TABLE 3

| | | Haze (%) | | Stress Cracking | | |
|---|---|---|---|---|---|---|
| | | “Air | “Slow | Medium | | |
| Sample | Resin | Cooled” | Cooled” | Stress | High Stress | Clarity |
| CE1 | A | 4.3 | 52.6 | n/a | cracked into | 3 |
| | | | | | two pieces | |
| CE2 | I | 1.7 | 13.5 | no cracks | large cracks | 2 |
| E1 | J* | 3 | 6.7 | no cracks | no cracks | 1 |

*Note: In the stress cracking tests, the ionomers used as Resin “J” had an acid level of 21 to 23%, and the melt index of the precursor acid copolymers was up to 245 g/10 min. The cation was sodium, and the neutralization level was approximately equal to that of Resin D as defined above.

While certain of the preferred embodiments of the present invention have been described and specifically exemplified above, it is not intended that the invention be limited to such embodiments. Various modifications may be made without departing from the scope and spirit of the present invention, as set forth in the following claims.

What is claimed is:

1. A lighting device comprising a light emitting diode and a molded cover comprising an ionomer that is produced by partially neutralizing a precursor acid copolymer, and the precursor acid copolymer comprises copolymerized units of an α-olefin having 2 to 10 carbons and, based on the total weight of the precursor acid copolymer, about 12 to about 30 weight % of copolymerized units of an α,β-ethylenically unsaturated carboxylic acid having 3 to 8 carbons; wherein the precursor acid copolymer has a melt flow rate (MFR) of about 200 g/10 min to about 400 g/10 min, as determined in accordance with ASTM D 1238 at 190° C. and under a weight of 2.16 kg; about 5% to about 90% of the total carboxylic acid content of the precursor acid copolymer is neutralized; and wherein the ionomer has a MFR of about 1 g/10 min to about 25 g/10 min, as determined in accordance with ASTM D-1238 at 190° C. and under a weight of 2.16 kg.

2. The lighting device of claim 1 wherein the haze of the ionomer composition is from about 0.5 to 13.5, when measured according to ASTM-1003 ASTM D1003 on a test plaque having a thickness of 3.0 mm, said test plaque made by melting the ionomer composition, forming the molten ionomer composition into the test plaque, and cooling the molten ionomer composition to a temperature of (22±3)° C. or less at a rate of 0.7° C./min or less.

3. The lighting device of claim 1, wherein about 20% to about 60% of the total carboxylic acid content of the precursor acid copolymer is neutralized and the ionomer comprises at least one metal cation.

4. The lighting device of claim 3, wherein the at least one metal ion is selected from the group consisting of ions of sodium, lithium, magnesium, zinc, potassium, and combinations of two or more of these ions.

5. The lighting device of claim 3, wherein the precursor acid copolymer comprises about 19.5 to about 25 weight % of copolymerized units of the α,β-ethylenically unsaturated carboxylic acid having 3 to 8 carbons and about 20% to about 50% of the total carboxylic acid content of the precursor acid copolymer is neutralized.

6. The lighting device of claim 3, wherein the precursor acid copolymer comprises about 15 to about 19 weight % of copolymerized units of the α,β-ethylenically unsaturated carboxylic acid having 3 to 8 carbons and about 20% to about 60% of the total carboxylic acid content of the precursor acid copolymer is neutralized.

7. The lighting device of claim 3, wherein the ionomer has a MFR of about 3 g/10 min to about 25 g/10 min.

8. The lighting device of claim 3, wherein the parent acid copolymer comprises from about 20 to about 23 weight % of copolymerized units of carboxylic acid moieties and wherein the ionomer has a MFR of about 1g/10 min to about 3 g/10 min.

9. The lighting device of claim 1, wherein the cover is in the form of a multi-layer structure, at least one layer of said multi-layer structure consists essentially of the ionomer composition.

10. The lighting device of claim 1, wherein the cover is produced by a process selected from the group consisting of extrusion molding, blow molding, injection stretch blow molding, thermoforming, compression molding and injection molding.

11. The lighting device of claim 10, wherein the cover is produced by a process selected from the group consisting of co-injection molding and over-molding.

12. The lighting device of claim 1 further comprising a power source electrically connected to the light emitting diode.

13. The lighting device of claim 1 wherein the light emitting diode is surrounded by the cover.

14. The lighting device of claim 1 wherein the cover is in contact with the light emitting diode.

15. The lighting device of claim 1 comprising a base wherein said base is attached to the cover, forming a bulb, and the light emitting diode is electrically connected to the base and contained within the bulb.

16. The lighting device of claim 1 wherein the cover is clear.

17. The lighting device of claim 1 wherein the cover is translucent.

18. A method for preparing a lighting device according to claim 1, the method comprising
(a) preparing a cover comprising an ionomer that is produced by partially neutralizing a precursor acid copolymer, and the precursor acid copolymer comprises copolymerized units of an α-olefin having 2 to 10 carbons and, based on the total weight of the precursor acid copolymer, about 12 to about 30 weight % of copolymerized units of an α,β-ethylenically unsaturated carboxylic acid having 3 to 8 carbons; wherein the precursor acid copolymer has a melt flow rate (MFR) of about 200 g/10 min to about 400 g/10 min, as determined in accordance with ASTM D 1238 at 190° C. and under a weight of 2.16 kg; about 5% to about 90% of the total carboxylic acid content of the precursor acid copolymer is neutralized; and wherein the ionomer has a MFR of about 2 g/10 min to about 25 g/10 min, as determined in accordance with ASTM D-1238 at 190° C. and under a weight of 2.16 kg; by extrusion molding, blow molding, injection stretch blow molding, thermoforming, compression molding, injection molding, co-injection molding or over-molding;
(b) providing a light emitting diode; and
(c) combining the cover and the light emitting diode.

19. The method of claim 18 further comprising combining the cover and the LED with a base.

20. The method of claim 18 wherein the haze of the ionomer composition is from about 0.5 to 13.5, when measured according to ASTM-1003 ASTM D1003 on a test plaque having a thickness of 3.0 mm, said test plaque made by melting the ionomer composition, forming the molten ionomer composition into the test plaque, and cooling the molten ionomer composition to a temperature of (22±3)° C. or less at a rate of 0.7° C./min or less.

21. The method of claim 18, wherein about 20% to about 60% of the total carboxylic acid content of the precursor acid copolymer is neutralized and the ionomer comprises at least one metal cation selected from the group consisting of ions of sodium, lithium, magnesium, zinc, potassium, and combinations of two or more of these ions.

22. The method of claim 18, wherein the precursor acid copolymer comprises about 19.5 to about 25 weight % of copolymerized units of the α,β-ethylenically unsaturated carboxylic acid having 3 to 8 carbons and about 20% to about 50% of the total carboxylic acid content of the precursor acid copolymer is neutralized.

23. The method of claim 18, wherein the precursor acid copolymer comprises about 15 to about 19 weight % of copolymerized units of the α,β-ethylenically unsaturated carboxylic acid having 3 to 8 carbons and about 20% to about 60% of the total carboxylic acid content of the precursor acid copolymer is neutralized.

24. The method of claim 18, wherein the ionomer has a MFR of about 3 g/10 min to about 25 g/10 min.

25. The method of claim 18, wherein the parent acid copolymer comprises from about 20 to about 23 weight % of copolymerized units of carboxylic acid moieties and wherein the ionomer has a MFR of about 1 g/10 min to about 3 g/10 min.
